(19) United States
(12) Patent Application Publication
(10) Pub. No.: US 2015/0251939 A1
(43) Pub. Date: Sep. 10, 2015

(54) COMPOSITION AND METHOD OF SCALE CONTROL IN REGULATED EVAPORATIVE SYSTEMS

(71) Applicant: HERCULES INCORPORATED, Wilmington, DE (US)

(72) Inventors: Christian Flocken, Krefeld (DE); Jay C. Henderson, Newark, DE (US); Christina Moering, Krefeld (DE)

(73) Assignee: HERCULES INCORPORATED, Wilmington, DE (US)

(21) Appl. No.: 14/250,459

(22) Filed: Apr. 11, 2014

Related U.S. Application Data
(60) Provisional application No. 61/948,829, filed on Mar. 6, 2014.

(51) Int. Cl. C02F 5/12

(52) U.S. Cl. CPC C02F 5/12; C02F 2101/10

(57) ABSTRACT

This invention pertains to a synergistic blend comprised of a polyamino acid and an anionic carboxylic polymer. The blend is able to effectively stabilize the calcium salts that lead to scale formation in evaporative systems. This blend shows high levels of efficacy in the acidic high conductivity waters found in many evaporative systems such as sugar and biorefining.

This application claims the benefit of U.S. provisional application No. 61/948,829, filed 6 Mar. 2014, the entire contents of which are hereby incorporated by reference.

### FIELD OF THE INVENTION

This invention relates to a composition comprising a polyamino acid and an anionic carboxylic polymer for controlling scale in aqueous systems, for example, in heat exchangers and evaporative equipment such as those found in regulated markets. The invention also relates to a method for removing, cleaning, preventing, and/or inhibiting the formation of scaling such as calcium, magnesium, oxalate, sulfate, and phosphate scale, of an aqueous system.

These systems have unique demands due to their high conductivities, high levels of insoluble material, and low pH regimes.

### BACKGROUND OF THE INVENTION

Scaling formation arises primarily from the presence of dissolved inorganic salts in the aqueous system that exists under supersaturation conditions of the process. The salts are formed when water is heated or cooled in heat transfer equipment such as heat exchangers, condensers, evaporators, cooling towers, boilers, and pipe walls. Changes in temperature or pH lead to scaling and fouling via the accumulation of undesired solid materials at interfaces. The accumulation of scale on heated surfaces cause the heat transfer coefficient to decline with time and will eventually, under heavy fouling, cause production rates to be unmet. Ultimately, the only option is often to shut down the process and perform a cleanup. This requires a shut down in production as well as use of corrosive acids and chelating agents. The economic loss due to fouling is one of the biggest problems in all industries dealing with heat transfer equipment. Scaling is responsible for equipment failures, production losses, costly repair, higher operating costs, and maintenance shutdowns.

In order to prevent scaling, a number of scale inhibitors are often employed in the field to prevent, delay, inhibit or otherwise control the scaling process. The presence of scale inhibitors can have a significant effect on nucleation; crystal growth rate and morphology, even when the additive is present in very low concentrations. However, these effects are not easily predicted as subtle changes in the pH, temperature, or types of scale can have significant impact.

In the food and beverage industry (such as beer, wine, concentrate liqueurs, vegetable juice, fruit juice, fuel ethanol, and sugar refining), one of the more common scale components is calcium oxalate). Oxalate is a natural component in plant life and can occur in high levels. During the course of processing the oxalate is extracted and becomes a part of the process waters. In the evaporators a small amount of oxalate will become concentrated and begin scaling upon supersaturation. In the lab we have found that calcium levels between 75-100 parts-per-million (ppm) are sufficient to cause precipitation of oxalate scale. Calcium oxalate also known as beerstone, and silica are the main components of composite scales formed in the later stages of the evaporation process in sugar mills, and form one of the most intractable scales to remove either by mechanical or chemical means. The removal of the scale is both costly and time consuming because of the tenacious nature of the deposit.

Known methods for treating calcium scale in evaporative systems include a number of chelating mechanisms. Most commonly this has been polymers containing carboxylic acids, phosphonate containing polymers, chelating agents such as ethylenediaminetetraacetic acid (EDTA), or small organic acids such as citric acid. Polyaspartic acid has also been used in some applications.

In some instances these materials have been blended in order to increase performance. Phosphonates and polycarboxylates (U.S. Pat. No. 4,575,425), blends of citric, gluconic, and gluconolactone (U.S. Pat. No. 3,328,304), polyacrylamide and alginate or phosphonate (U.S. Pat. No. 3,483,033), phosphonic acids and EDTA (US 20100000579 A1), blends of chelating agents including EDTA (WO 2012/142396 A1), and hydroxycarboxylic acids with citric acid (US 20120277141 A1). Many of these compositions are shown to be effective to some extent but often require high doses or materials that do not have proper regulatory clearance for food and beverage products.

Polyaspartic acid has shown some level of efficacy in inhibiting calcium scales in sugar applications but required synthetic modifications to achieve higher performance (U.S. Pat. No. 5,747,635). Polyacrylates have also been applied to similar scales (U.S. Pat. No. 4,452,703). The use of these materials has been limited to doses resulting in very low residuals of 3.6 to 5.0 ppm. Neither of these materials appears to be sufficiently effective at such low doses to be useful in large scale applications.

Polyaspartic acid has previously shown synergy with phosphonated anionic copolymers. This synergy was limited to cooling tower waters and phosphate scales. (U.S. Pat. No. 6,207,079 B1, U.S. Pat. No. 6,503,400 B2). These systems differ from the current application in that the level of salts present in the '079 and the '400 patents is considerably lower, the pH is higher, and unexpected improvement was only shown for phosphates. Evaporative processes in regulated food and beverage market must contend with high conductivities ranging from about 10,000 microseconds per centimeter (μS/cm) to about 20,000 μS/cm. The pH can range from about 2.0 (lemon/lime, blueberry, wine, cranberry) to about 9.0 (milk, sugar) with high levels of solids (>10%). Cooling waters are typically well below 8,000 μS/cm and have a pH>7.2. The plant matter can often bring high levels of phosphates and sulfates, as high as about 10,000-20,000 ppm with significant amounts of calcium, magnesium, and other metals not typically present in such high levels in other circulating water systems.

The use of the present polymer treatment will have the benefit of minimizing the use of energy, increasing production, decreasing the time and chemicals used for cleaning, and thereby lessen the need for outages and downtime. An additional benefit of the present polymer treatment is the decreased maintenance of heat exchangers and evaporators.

The current composition also has enhanced performance at preventing other scales and deposits to form. Deposit formation is a complicated process that can often occur when one type of scale combines with another to form a larger deposit. By inhibiting the oxalate scale benefits would be expected in the reduction of organic deposits such as pitches and stickies as well as inorganic scales such as silicates.

Polyaspartic acid has also been shown to exhibit corrosion inhibition properties in a wide range of applications. This additional benefit of the present composition over the use of polyacrylate alone can further decrease the cost of maintenance and related down time.

### SUMMARY OF THE INVENTION

This invention pertains to a composition comprising a polyaspartic acid and an anionic carboxylic polymer. The composition is able to effectively stabilize calcium, magnesium, oxalate, sulfate, and phosphate salts that lead to scale formation in evaporative systems. This composition shows high levels of efficacy in high conductivity waters found in many evaporative systems such as sugar; biorefining and other regulated systems.

The present compositions provide stabilization of salts such as calcium, magnesium, oxalate, sulfate, and phosphate salts by reacting together to inhibit scale formation; prevent contaminant growth and acts as a dispersant. Specifically, the composition is able to stabilize calcium oxalate and prevent the formation of scale in the presence of high levels of sulfates, phosphates, magnesium, and other cations and anions commonly found during evaporative stages or other processes involved in the refining of sugar, biorefining, liqueur and beer, fruit and vegetable juice, and dairy products such as milk. The current process is comprised of treating an aqueous system with a) a low molecular weight polyacrylic acid and b) polyaspartic acid in a ratio compliant with a use dosage in compliance with regulatory requirements.

The compositions of the present invention are considered to be synergistic because while neither material is individually shown to be effective salt stabilizers at the approved regulatory levels, wherein the blend of polyacrylates and polyaspartates gives a level of performance unexpected and superior to either polymer alone. These blends are able to stabilize calcium, oxalate and phosphate scales more than would be expected based on the individual performance of each material. The polyacrylate/polyaspartate blend is further advantageous over many other existing blends as the polyaspartic acid is known to be biodegradable and is a known corrosion inhibitor. The term blend is interchangeably used with pre-mixed, and is used to mean the polyacrylates and polyaspartates are mixed together prior to being added to the aqueous system. However, the polyacrylates and polyaspartates can be added to the system simultaneously or sequentially at various addition points as long as the polyacrylates and polyaspartates have residence time with one another.

An aspect of the current composition is that the components of the composition are recognized as safe by the Regulatory Commission such that it does not compromise the potential end use of the product. Regulated products may be consumed by humans or livestock and the presence of the chemical additive cannot interfere with the use or end use of the product or by-products such as dry distiller grains.

The invention also pertains to a method for removing, cleaning, preventing, and/or inhibiting the formation of scaling such as calcium, magnesium, oxalate, sulfate, and phosphate scale, comprising adding a polyacrylate and a polyaspartate to an aqueous system.

Additional objects, advantages, and features of what is claimed will be set forth in the description that follows and in part will become apparent to those skilled in the art upon examination of the following or may be learned by the practice of the technology. The objects and advantages of the presently disclosed and claimed inventive concepts will be realized and attained by means of the compositions and methods particularly pointed out in the appended claims, including the functional equivalents thereof.

### DRAWINGS

FIG. 1, shows a measure of the rate at which scale is deposited on the gold electrode surface.

FIG. 2, shows a general schematic of the main features of the procedure for determining Cycles of Concentration (COC).

FIG. 3, shows the Cycles of Concentration (COC) of calcium oxalate over time.

FIG. 4, shows the Cycles of Concentration (COC) of calcium oxalate over time.

FIG. 5, shows the Cycles of Concentration (COC) of calcium oxalate over time.

FIG. 6, shows the solubility of calcium oxalate as a function of pH.

### DETAILED DESCRIPTION OF THE INVENTION

The present invention relates to a composition and method to remove, clean, prevent, and/or inhibit the formation of calcium, magnesium, oxalate, sulfate, and phosphate scale and deposits in an aqueous system. Furthermore, it relates to a method for controlling the formation of scale in aqueous systems and inhibiting scale deposition on surfaces such as heat exchanger and evaporator equipment.

In one embodiment a composition comprising a polyaspartic acid and an anionic carboxylic polymer and the composition is added to an aqueous system for controlling scaling. The composition can be added to an aqueous system premixed, simultaneously or sequentially. For example, the chemicals can be blended together or pre-mixed prior to introduction into the system, or the polyaspartic acid and carboxylic polymer can be added separately, but simultaneously or, they can be added sequentially at various points in a system as long as the chemicals can come into contact with each other to react. It does not matter the order of addition.

In another embodiment component (a) of the scale inhibitor composition is a polyaspartic acid. This includes polyaspartic salts and derivatives of polyaspartic acid such as the anhydrides used to form polyaspartic acid. The polyaspartic acid can also comprise a copolymer of aspartic and succinct monomer units. These polyaspartic acids have molecular weights ranging from about 500 to about 10,000, can be from about 1,000 to about 5,000, and may be from about 1,000 to about 4,000. The polyaspartic acid can be used as a salt, such as sodium or potassium salt.

In another embodiment, component (b) is an anionic carboxylic polymer or salt thereof. The carboxylic polymer is construed of any product formed by the polymerization of one or more monomers and can include one or more homopolymers, copolymers, terpolymers or tetrapolymers, etc. The anionic carboxylic polymer typically has an average molecular weight of from about 500 to about 20,000 and can be from about 1,000 to about 50,000. These polymers and their method of synthesis are well known in the art.

In another embodiment, monomers that can provide the source for the carboxylic functionality for the anionic carboxylic polymer include acrylic acid, maleic acid, methacrylic acid, carboxy-methyl inulin, crotonic acid, isocrotonic acid, fumaric acid, and itaconic acid. Numerous co-monomers can be polymerized with the monomer containing the carboxylic functionality. Examples such as vinyl, allyl, acrylamide, (meth) acrylate esters, and hydroxyl esters such as hydroxypropyl esters, vinyl pyrrolidone, vinyl acetate, acrylonitrile, vinyl methyl ether, 2-acrylamido-2-methyl-propane sulphonic acid, vinyl or allyl sulphonic acid, styrene sulphonic acid, and combinations thereof. The molar ratio of carboxylic acid functionalized to co monomer can vary over a wide range such as from about 99:1 to 1:99 and can be from about 95:5 to 25:75.

It is also possible to employ carboxylic acid polymers that contain a phosphonate or other phosphorous containing functionality in the polymer chain, preferably phosphino polycarboxylic acids such as those in U.S. Pat. No. 4,692,317 and U.S. Pat. No. 2,957,931.

Other optional components include phophonobutane tricarboxylic, polyphosphates, phosphates, hydroxyethylidene diphosphonic acid, amino trimethylene phosphonic acid), citric acid, gluconic acid, and other small organic acids.

The polycarboxylic acid and polyaspartic acid can be considered the active ingredients of the dual agent compositions of the invention and these two ingredients together are referred to as “active agents” or “actives”. Therefore, concentrations and amounts used herein are based on actives.

The effective ratio of carboxylic acid polymer to polyaspartic acid is from 1:9 to 9:1, and can be from 1:3 to 1:1. The compositions have an effective pH range of from about 1.0 to about 9.0, can be from about 2.5 to about 7, and may be from about 3.0 to about 5.0. The composition functions over a wide range of temperatures of from about 5° C. to about 175° C. The composition is dosed at a minimum dosage of from about 0.1 ppm to about 500.0 ppm, and may be from about 1.0 ppm to about 50.0 ppm based on actives.

The following examples illustrate specific embodiments of the invention. It is likely that many similar and equivalent embodiments of the invention will also apply outside of those specifically disclosed. One skilled in the art will appreciate that although specific compounds and conditions are outlined in the following examples, these compounds and conditions are not a limitation on the present invention.

### Examples

The invention has been described with reference to a preferred embodiment, those skilled in the art will understand that changes can be made and equivalent substitutions made for certain components without departing from the scope of the invention. Additionally, modifications may be made to adapt to specific conditions or materials without departing from the scope thereof. Additionally, any future changes in the regulations pertaining to the restricted dosage limits fall within the scope of this invention. It is intended that the invention not be limited to a particular embodiment disclosed but that the invention will include all embodiments falling with the scope of the claims.

Example 1, demonstrates the benefit of dosing with the present invention as opposed to the individual polymers alone. The dosages are given in ppm as solids for each product. The test method used is described as follows:

### Test Method

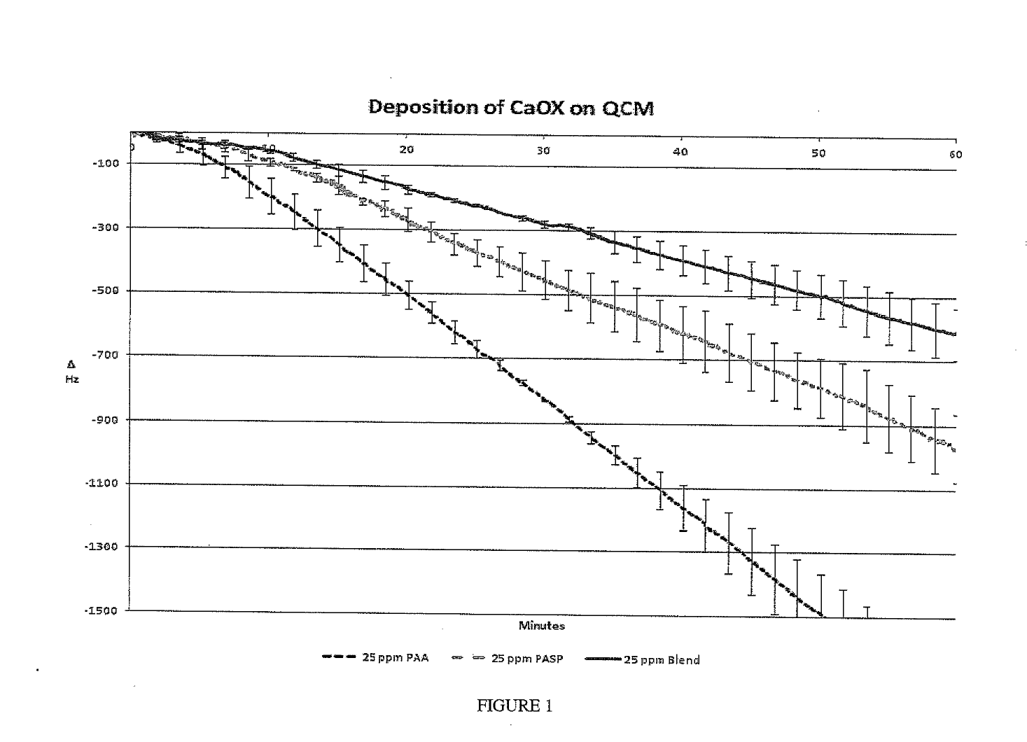

Testing was performed using a quartz crystal microbalance to measure the rate at which scale deposited on the gold electrode surface using test waters that mimicked the conditions found in a typical biorefining evaporator. The test solution was made up as follows: 1,500 parts-per-million (ppm) magnesium, 750 ppm oxalate, 3,755 ppm sulfate, 6,415 ppm phosphate in deionized water. This was then adjusted to a pH between 3.6 and 3.8. The inhibitors were then dosed at 25 ppm for the polyacrylate, 25 ppm for polyaspartate, or in the case of the blend, 10 ppm polyacrylate and 15 ppm polyaspartate. A quartz crystal microbalance (QCM) electrode was then inserted into the test solution which was subsequently placed in a water bath at 50° Celsius (C) and allowed to equilibrate. At this point a stock solution of calcium was used to add enough calcium to the test waters to result in a final concentration of 250 ppm calcium. The change in frequency on the electrode was then recorded for sixty minutes. Steeper negative slopes indicate greater buildup of scale on the electrode surface. The tests were repeated three times each and averaged. Tests performed in the absence of calcium or oxalate resulted in no change in frequency with a slope of essentially zero. FIG. 1, shows the results of the testing clearly indicates that the composition comprising the polyacrylates/polyaspartate blend, significantly outperformed the individual polymers alone at equal dosing. Example 2, illustrates the efficiency of the polyacrylates/polyaspartate mixture compared with the individual polymers alone, using an evaporative dynamic scale inhibition test method. The dosages are given in parts-per-million (ppm) as solids for each product. The test method used is described as follows:

### Test Method

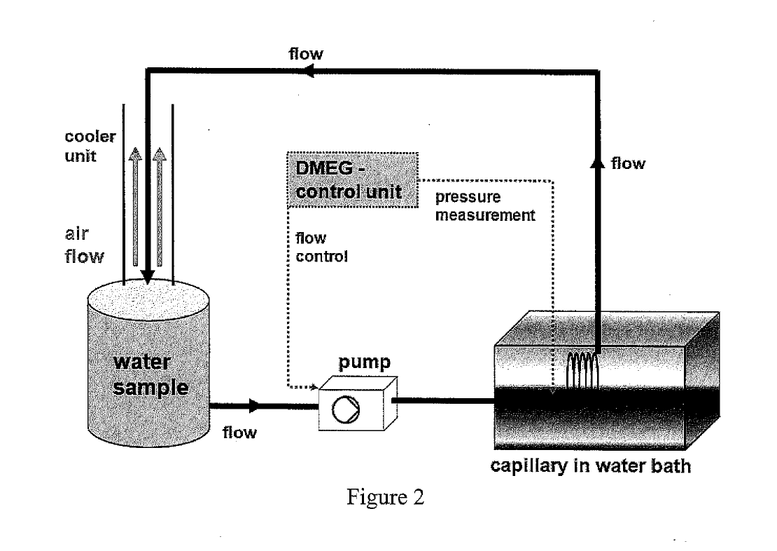

The following measurement is performed with a Druckmessgerat Haas V2.2 measurement and control unit (DMEG), manufactured by Franz-Josef Haas haasfranz@yahoo.de. FIG. 2, illustrates the equipment and procedure test set-up.

A constant volume flow of 2 liter per hour (L/h) of a stoichiometric mixture prepared from a solution of calcium chloride dihydrate and sodium oxalate in de-mineralized water was passed through a spiral metal capillary (length: 1 meter (m), inner diameter: 1.1 millimeter (mm) placed in a heating bath at 40° C. The calculated calcium oxalate concentration was 15 milligram per liter (mg/L) and the pH was adjusted to 4.0. The scale prevention product was added before sodium oxalate was added to the calcium chloride solution. The inhibitors were dosed at 25 ppm for the polyacrylate, 25 ppm for polyaspartate, or a blend of 10 ppm polyacrylate and 15 ppm polyaspartate. Test water was pumped in a circuit from a flask through a capillary tube in a water bath, through a cooler and back to the flask. In the water bath a heat exchange occurred and the test water was heated up. The test water was then passed through a cooler unit where an adjusted air flow from below caused evaporation. Due to the evaporation the test water was concentrated. During the experiment samples of the test water were taken. The sample was filtered through a 0.45 micrometer (μm) filter followed by concentration determination of chloride ion and calcium ion.

The Cycles of Concentration (COC) can be calculated by dividing the analyzed concentration of a compound by the initial concentration. The chloride concentration describes the concentration of the system as the solubility of chloride is high. A loss of calcium by precipitation as calcium oxalate will result in a deviation of the COC for chloride and the COC for calcium. In this way the maximum COC reached without scaling can be determined for each product at the same dosage.

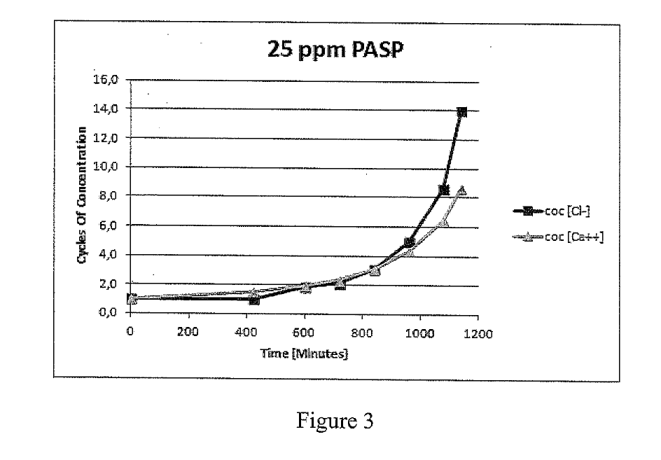

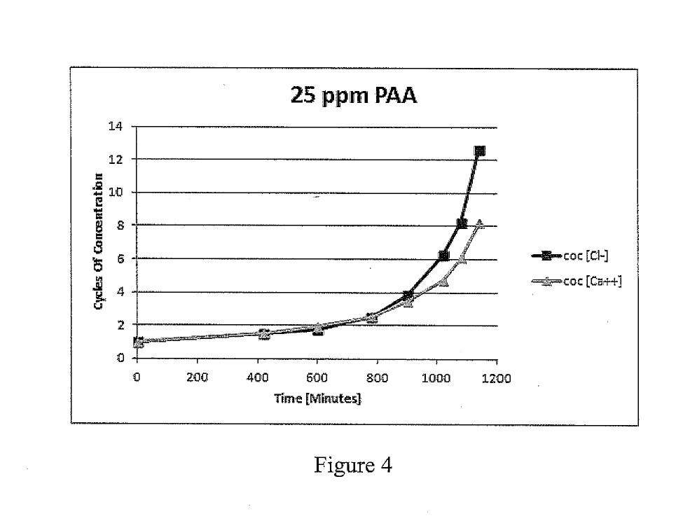

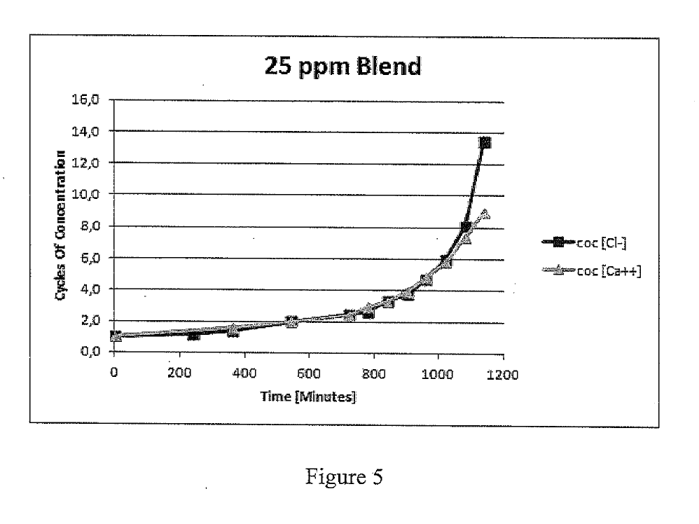

FIGS. 3-5 and Tables 1-3, describe the results of the tests.

TABLE 1

| | Maximum cycles of concentration |
|---|---|
| PASP | 3.1 |
| PAA | 2.5 |
| Blend | 4.9 |

As it can be seen the maximum cycles of concentration (COC) reached with the blended product was significantly higher than with the individual polymers.

Example 3, compares the efficiency of a polyacrylate/polyaspartate mixture compared with the individual polymers using an evaporative dynamic scale inhibition test method at a lower pH and a higher calcium oxalate concentration than described in example 2.

Except for pH and calcium and oxalate concentration, the test set-up and procedure was the same than described in example 2. The pH of the test water was adjusted to pH 2.0. The calculated calcium oxalate concentration was 110 mg/L; oxalate was added in a stoichiometrical ratio and calcium in a fivefold stoichiometrical ratio. The following table presents the maximum Cycles of Concentration (COC) observed for the scale inhibitors. The inhibitors were again dosed at 25 ppm for the polyacrylate, 25 ppm for polyaspartate and in the blend 10 ppm polyacrylate and 15 ppm polyaspartate. The dosages are given in ppm as solids.

TABLE 2

| | Maximum cycles of concentration |
|---|---|
| PASP | 1.9 |
| PAA | 1.5 |
| Blend | 2.8 |

A synergistic effect could be observed also at a lower pH and a higher calcium oxalate concentration. The blended product performed significantly better than the single polymers. The system could be stabilized to a higher maximum COC.

Example 4, shows the performance of a polyacrylate/polyaspartate mixture compared with the individual polymers using an evaporative static scale inhibition test method at a pH of 6.5 and 9.0.

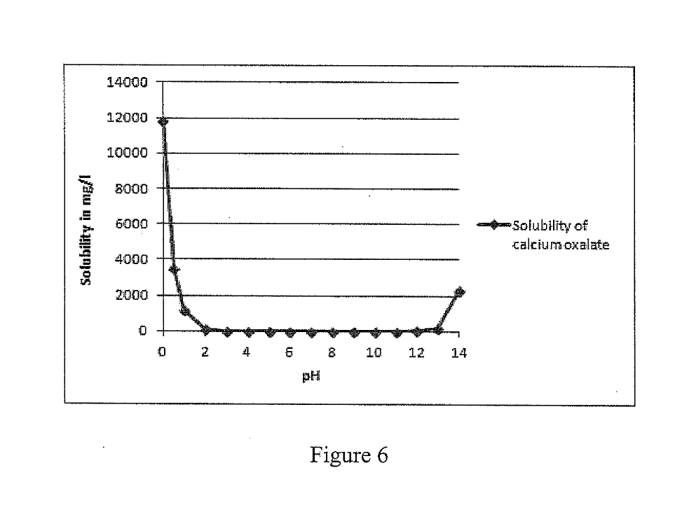

The solubility of calcium oxalate depending on pH is shown in FIG. 6.

Example 5, the solubility of chloride and calcium at pH 6.5 and 9.0 is even higher at 7.5 mg/L compared with 1.2 mg/L at the previously tested pH of 4.0. Therefore, similar results were expected concerning the scale inhibition performance. A test set-up was chosen for testing the stabilization efficiency at two Cycles of Concentration (COC). One point was chosen in the area where a stable system is expected, a second point was analyzed where the system was expected to be instable. In this way a range for each composition could be identified where the system becomes instable.

A solution of calcium chloride dihydrate and sodium oxalate in de-mineralized water adjusted to pH 6.5, respectively 9.0 was stirred in a beaker using a magnetic stirrer. The temperature was set to 40° C. The calculated calcium oxalate concentration was 15 mg/L. The scale prevention product was again added before sodium oxalate was given to the calcium chloride solution. The inhibitors were dosed at 25 ppm for the polyacrylate, 25 ppm for polyaspartate, or in the blend 10 ppm polyacrylate and 15 ppm polyaspartate. An air flow was used to cause evaporation. Due to the evaporation the test water was concentrated. As described before a sample was taken at two measuring points. The sample was filtered through a 0.45 μm filter followed by concentration determinations of chloride and calcium used to calculate the COC.

TABLE 3, presents the COC range where the system became instable.

TABLE 3

COC

| | pH 6.5 | pH 9 |
|---|---|---|
| PASP | 3.0-3.9 | 3.0-4.0 |
| PAA | 2.3-3.4 | 2.8-3.6 |
| Blend | 4.6-7.8 | 4.5-7.5 |

As can be seen from this study, a synergistic effect is observed at pH 6.5 and 9.0. A significantly higher COC range could be reached with the blended product than with the individual polymer.

1. A method for controlling, preventing and/or inhibiting the formation of scale and/or deposits in an aqueous system comprising;
adding to the aqueous system a composition comprising a) a polyaspartic acid; and b) an anionic carboxylic polymer; wherein the polyaspartic acid and carboxylic polymer can be added to the aqueous system premixed, simultaneously or sequentially.

2. The method according to claim 1, wherein the polyaspartic acid and carboxylic polymer are premixed prior to being added to the system.

3. The method of claim 1 or 2, wherein the scale and/or deposits are calcium, magnesium, oxalate, sulfate, and phosphate salts.

4. The method of claim 3, wherein the calcium and/or magnesium scale are from oxalates, carbonates, and silicates.

5. The method of claim 1, wherein the weight ratio of solids of component (a) to component (b) is from about 1:10 to 10:1.

6. The method of claim 1, wherein component b) of the composition is selected from at least one of homopolymers, copolymers, terpolymers and tetrapolymers

7. The method of claim 1, wherein component b) of the composition is selected from the group consisting of acrylic/sulfonic polymers, acrylic/maleic copolymers, phosphinocarboxylic, acryl/maleic/sulfonated styrene, acrylic/ethoxylate/acrylamide, maleic/ethylacrylate/vinyl acetate and mixtures thereof.

8. The method of claim 1, where component a) of the composition has an average molecular weight from about 500 to about 10,000.

9. The method of claim 1, wherein the concentration of the composition added to the aqueous system is from about 0.1 ppm to about 500 ppm based on actives.

10. The method of claim 1, wherein the composition optionally contains citric acid, sodium phosphate, tartaric acid, gluconic acid, and/or small organic acids.

11. The method of claim 1, wherein the pH of the aqueous system is from about 1.0 to about 9.0.

12. The method of 11, wherein the pH of the aqueous system is from about 3.0 to about 5.0.

13. The method of claim 1, wherein the aqueous system comprises heat exchangers and/or evaporating equipment.

14. The method of claim 1, wherein the aqueous system is selected from the group consisting of regulated food process for direct or indirect food consumption; biofinery and fuel ethanol processes; sugar processing; fruit and vegetable juice concentrating processes; and food, alcohol and fermentation processes.

15. The method of claim 14, wherein the alcohol or fermentation process comprises beer, wine and concentrate liquors.

16. The method of claim 14, wherein the regulated food processes comprise milk and dairy processes.

17. A composition for controlling, preventing and/or inhibiting the formation of scale and/or deposits in an aqueous system comprising;
a) a polyaspartic acid; and b) an anionic carboxylic polymer.

18. The composition of any one of claim 17, wherein the weight ratio of solids of component (a) to component (b) is from about 1:10 to 10:1.

19. The composition of claim 17, wherein component b) of the composition is selected from the group consisting of homopolymers, copolymers, terpolymers and tetrapolymers.

20. The composition of claim 19, wherein component b) of the composition is selected from the group consisting of acrylic/sulfonic polymers, acrylic/maleic copolymers, phosphinocarboxylic, acryl/maleic/sulfonated styrene, acrylic/ethoxylate/acrylamide, maleic/ethylacrylate/vinyl acetate and mixtures thereof.
